(19) United States
(12) Patent Application Publication
(10) Pub. No.: US 2022/0106434 A1
(43) Pub. Date: Apr. 7, 2022

(54) Foamable, multi-component composition which forms an insulation layer, and use thereof

(71) Applicant: Hilti Aktiengesellschaft, Schaan (LI)

(72) Inventors: Mario PAETOW, Landsberg am Lech (DE); Jekaterina Miller, Ostfildern (DE)

(73) Assignee: Hilti Aktiengesellschaft, Schaan (LI)

(21) Appl. No.: 17/426,684

(22) PCT Filed: Jan. 27, 2020
(86) PCT No.: PCT/EP2020/051876

§ 371 Date: Jul. 29, 2021

(30) Foreign Application Priority Data
Feb. 12, 2019 (EP) 19156628.0

(51) Int. Cl. C08G 18/48; C08G 18/38; C08G 18/73; C08G 18/79; C08J 9/12

(52) U.S. Cl. CPC C08G 18/4829; C08G 18/3821; C08G 18/4833; C08G 2101/00; C08G 18/791; C08J 9/125; C08G 18/73

(57) ABSTRACT

A foamable, multi-component composition based on polyurea and/or polyurethane forms an insulation layer. The composition can be used for foaming openings, cable and pipe feedthroughs, and joints for the purpose of fire protection.

The present invention relates to a foamable, multi-component composition based on polyurea and/or polyurethane that forms an insulation layer, and the use thereof for foaming openings, cable and pipe feedthroughs and joints for the purpose of fire protection.

Polyurethanes and/or polyureas are often used as binders for mounting, insulating and fire protection foams. These can be applied, for example, as 1K or 2K aerosol cans or as 2K cartridge foam. The curing component in this case comprises isocyanates which react with polyols or polyamines by polyaddition to form polyurethanes and/or polyureas. In this case, aromatic isocyanates are used most frequently. These have been considered a hazardous substance for a long time, are subject to H351 labeling and should only be used by trained users.

One approach to solving this is what is referred to as “low MDI foams,” in which isocyanate prepolymers having an aromatic isocyanate content of, for example, less than 1% or even 0.1% are used, as described, for example, in DE 102010038355 A1 or DE 10357093 A1.

Another approach to solving this is based on the use of “modified silanes” (also STP, silane-terminated polymer). These polymers, which often have a polyurethane or polyether skeleton, cure by means of hydrolysis and polycondensation reaction of the alkoxysilyl groups. Foams of this kind are commercially available as insulation foams in pressurized cans. The canned foams are generally foamed using a physical blowing agent. Systems of this kind are known, for example, from WO 2000/004069 A1, US 2006/189705 A, WO 2013/107744 A1 or WO 2013/045422 A1.

Even if, in comparison with aromatic isocyanates, aliphatic isocyanates are not subject to H351 labeling, aliphatic isocyanates generally have a lower reactivity than aromatic isocyanates. As a result, the use thereof in fire protection systems is very limited. When aromatic isocyanates are replaced with aliphatic isocyanates, the properties of the fire protection system generally deteriorate. In particular, insufficient curing and foam rise times are achieved when using aliphatic isocyanates in fire protection foams.

Foams based on aromatic isocyanates continue to show inadequate application properties because the applied foam is often so hard that it can only be molded poorly or not at all. It is therefore difficult for the user to bring the applied foam into the desired shape.

The aim of the invention is therefore to provide foams, in particular in-situ foams, which do not have the aforementioned disadvantages of the known systems, and which are suitable for fire protection. In particular, the aim of the present invention is to provide a fire protection foam in a manner which uses aliphatic isocyanates and excludes aromatic isocyanates, which foam has a sufficient ash crust stability for use as a fire protection foam. Furthermore, the foam is intended to have sufficient curing and foam rise times and be characterized by an improved expansion factor.

This aim is achieved by the multi-component composition according to claim 1. Preferred embodiments can be found in the dependent claims, which can optionally be combined with one another.

The present invention further relates to the use of the multicomponent composition according to the invention, according to claim 13.

The invention accordingly relates to a foamable, multi-component composition which forms an insulation layer, comprising
i) at least one aliphatic isocyanate compound having an average NCO functionality of 1 or more,
ii) at least one reactive component which is reactive to isocyanate groups, selected from the group consisting of compounds having at least two amino groups, polyols and combinations thereof,
iii) at least one fire protection additive which forms an insulation layer, and
iv) a blowing agent comprising one or more compounds which are able to release CO₂ by reaction,
the individual constituents of the blowing agent being separated from one another in a reaction-inhibiting manner before the multicomponent composition is used, and the aliphatic isocyanate compound being separated from the reactive component, which is reactive to isocyanate groups, in a reaction-inhibiting manner.

For a better understanding of the invention, the following explanations of the terminology used herein are considered useful. In the context of the invention:
the term “aliphatic compound” includes acyclic and cyclic, saturated or unsaturated hydrocarbon compounds which are not aromatic (PAC, 1995, 67, 1307; Glossary of class names of organic compounds and reactivity intermediates based on structure (IUPAC Recommendations 1995));
“polyamine” means a saturated, open-chain or cyclic organic compound which is interrupted by a changing number of secondary amino groups (—NH—) and which, in particular in the case of the open-chain compounds, has primary amino groups (—NH₂) at the chain ends;
“organic functional group” means a hydrocarbon functional group which can be saturated or unsaturated, substituted or unsubstituted, aliphatic, aromatic or araliphatic; where “araliphatic” means that aromatic and aliphatic functional groups are contained.
“chemical intumescence” means the formation of a voluminous, insulating ash layer by means of compounds which are matched to one another and react with one another under the effect of heat;
“physical intumescence” means the formation of a voluminous, insulating layer by means of expansion of a compound that releases gases under the effect of heat, as a result of which the volume of the compound increases by a multiple of the original volume;
“insulation-layer-forming” means that, in the event of a fire, a firm micro-porous carbon foam is formed, such that the fine-pored and thick foam layer that is formed, referred to as the ash crust, insulates a substrate against heat, depending on the composition;
a “carbon source” is an organic compound which leaves a carbon skeleton behind due to incomplete combustion, and does not combust completely to form carbon dioxide and water (carbonization); these compounds are also referred to as “carbon-skeleton formers”;
an “acid former” is a compound that forms a non-volatile acid under the effect of heat, i.e. above approximately 150° C., for example by decomposition, and thereby acts as a catalyst for carbonization; in addition, it can contribute to lowering the viscosity of the melt of the binder; the term “dehydrogenation catalyst” is therefore used as an equivalent;
a “gas former” is a compound which decomposes at an elevated temperature to develop inert, i.e. non-combustible, gases and optionally expands the softened binder into a foam (intumescence);
an “ash crust stabilizer” is what is referred to as a skeleton-forming compound, which stabilizes the carbon skeleton (ash crust) which is formed from the interaction of the carbon formation from the carbon source and the gas from the gas formers, or the physical intumescence;
the term “polyol” is a collective term for polyhydric alcohols. This is in particular understood to mean low-molecular and macromolecular compounds which contain at least two alcoholic hydroxyl groups (—OH) in the molecule (Römpp, Chemistry Encyclopedia),

In the context of the present description, the term “composition” is used synonymously for the term multicomponent composition according to the invention, or foamable multicomponent composition which forms an insulating layer.

According to the invention, the multicomponent composition comprises at least one aliphatic isocyanate compound having an average NCO functionality of 1 or more. All aliphatic isocyanates known to a person skilled in the art that have an average NCO functionality of 1 or more, preferably greater than 2, can be used individually or in any mixtures as the isocyanate compound.

The aliphatic isocyanate compounds used are preferably free from aromatic isocyanate compounds. In the context of this application, this means that the aliphatic isocyanate compound used, or a mixture of aliphatic isocyanate compounds, contains less than 10 wt. %, preferably less than 5 wt. % and more preferably less than 3 wt. %, of aromatic isocyanate compounds, based on the total weight of all isocyanate compounds in the multicomponent composition.

The aliphatic isocyanates preferably have a carbon skeleton (excluding the contained NCO groups) of 3 to 30, preferably 4 to 20. Examples of aliphatic polyisocyanates are bis(isocyanatoalkyl) ether or alkane diisocyanates, such as propane diisocyanates, butane diisocyanates, pentane diisocyanates, hexane diisocyanates (e.g. hexamethylene diisocyanate, HDI), heptane diisocyanates, octane diisocyanates, nonane dilsocyanates (e.g. trimethyl-HDI (TMDI) usually as a mixture of the 2,4,4 and 2,2,4 isomers), 2-methylpentane-1,5-diisocyanate (MPDI), nonane triisocyanates (e.g. 4-isocyanatomethyl-1,8-octane diisocyanate), decane diisocyanates, decane triisocyanates, undecane dilsocyanates, undecane triisocyanates, dodecane diisocyanates, dodecane triisocyanates, 1,3- and 1,4-bis(isocyanatomethyl)cyclohexanes (H₆XDI), 3-isocyanatomethyl-3,5,5-trimethylcyclohexyl isocyanate (isophorone diisocyanate, bis(4-isocyanatocyclohexyl)methane (H₁₂MDI), bis(isocyanatomethyl)norbornane (NBDI) or 3(4)-isocyanatomethyl-1-methyl-cyclohexyl isocyanate (IMCI).

Particularly preferred isocyanates are hexamethylene diisocyanate (HDI) and the homopolymers thereof, trimethyl-HDI (TMDI), 2-methylpentane-1,5-diisocyanate (MPDI), isophorone diisocyanate (IPDI), 1,3 and 1,4-bis(isocyanatomethyl)cyclohexane (H6XDI), bis(isocyanatomethyl)norbornane (NBDI), 3(4)-isocyanatomethyl-1-methyl-cyclohexyl isocyanate (IMCI) and/or 4,4′-bis(isocyanatocyclohexyl)methane (H12MDI) or mixtures of said isocyanates.

The aliphatic isocyanates can also be present in the form of prepolymers, biurets, isocyanurates, iminooxadiazinediones, uretdiones and/or allophanates, which are prepared by reacting with polyols or polyamines, individually or as a mixture, and which have an average functionality of 1 or more, preferably 2 or more.

Examples of suitable, commercially available isocyanates are Desmodur® N 3900, Desmodur® N 100, Desmodur® N 3200, Desmodur® N 3300, Desmodur® N 3600, Desmodus® N 3800, Desmodur® 2731, Desmodur® N 3400, Desmodus® XP 2580, Desmodur® XP 2679, Desmodus® XP 2731, Desmodur® XP 2489, Desmodur® E 305, Desmodur® E 3370, Desmodur® XP 2599, Desmodur® XP 2617, Desmodur® XP 2406 (each from Covestro AG); Vestanat® products from Evonik; Tolonate HDB, Tolonate HDT (Rhodin; Vencorex); Duranate™ from Asahi Kasei; HDI-based products from Tosoh/NPU; WANNATE®HDI from Wanhua Basonat HE 100 and Basonat HI 100 (BASF).

The aliphatic isocyanate compounds can each be used individually or as a mixture of two or more compounds.

The sum of all aliphatic isocyanate compounds contained in the multicomponent composition is preferably 25 to 55 wt. %, particularly preferably 30 to 50 wt. %, based on the total weight of the multicomponent composition.

The weight percentage quantitative proportions of the aliphatic isocyanate compound and the reactive component which is reactive to isocyanate groups is preferably selected such that the equivalent proportion of isocyanate groups of the isocyanate compound to groups, which are reactive to the isocyanate group, of the reactive component which is reactive to isocyanate compounds is between 0.3 and 1.7, preferably between 0.5 and 1.5 and more preferably between 0.9 and 1.4.

According to the invention, the multicomponent composition comprises at least one reactive component which is reactive toward isocyanate groups and is selected from the group consisting of compounds having at least two amino groups, polyols and combinations thereof.

Usable amines are all compounds which have at least two amino groups, the amino groups being primary and/or secondary amino groups which are able to react with isocyanate groups to form a urea group (—N—C(O)—N), these compounds being known to a person skilled in the art.

In one embodiment of the invention, the amine is a polyamine, such as 1,2-diaminocyclohexane, 4,4′-diaminodiphenyl sulfone, 1,5-diamino-2-methylpentane, diethylenetriamine, hexamethylenediamine, isophoronediamine, triethylenetetramine, trimethylhexamethylenediamine and 5-amino-1,3,3-trimethylcyclohexane-1-methylamine.

These polyamines are highly reactive to isocyanate groups, such that the reaction between the amino group and the isocyanate group takes place within a few seconds. For this reason, it is essential to the invention that the compounds having at least two amino groups are separated from the aliphatic isocyanate compound(s) in a reaction-inhibiting manner before the multicomponent composition is used.

Compounds which react less quickly with the isocyanate groups, such as what are referred to as polyether polyamines, are therefore preferably used. The polyether polyamines, also referred to as alkoxylated polyamines or polyoxyalkene polyamines, comprise compounds having aliphatically bound amino groups, i.e. the amino groups are attached to the ends of a polyether backbone. The polyether skeleton is based on pure or mixed polyalkylene oxide units, such as polyethylene glycol (PEG), polypropylene glycol (PPG). The polyether skeleton can be obtained by reacting a di- or tri-alcohol initiator with ethylene oxide (EO) and/or propylene oxide (PO) and then converting the terminal hydroxyl groups into amino groups.

Suitable polyether polyamines are represented by the following general formula (I)

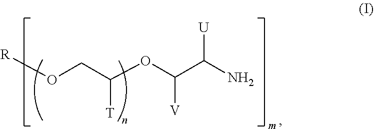

in which
R is the functional group of an initiator for the oxyalkylation, having 2 to 12 carbon atoms and 2 to 8 groups having active hydrogen atoms,
T represents hydrogen or a C1-C4 alkyl group,
V and U, independently of one another, are hydrogen or T,
n is a value between 0 and 100,
m is an integer between 2 and 8,
where m corresponds to the number of groups having an active hydrogen atom that were originally contained in the initiator for the oxyalkylation.

In further embodiments, n has a value between 35 and 100 or less than 90, less than 80 and less than 70 or less than 60. In a further embodiment, R has 2 to 6, or 2 to 4, or 3 groups having active hydrogen atoms, in particular hydroxyl groups. In another embodiment, R is an aliphatic initiator having a plurality of active hydrogen atoms. In a further embodiment, T, U and V are each methyl groups.

Examples of suitable polyetheramines are the D, ED, EDR and T-series polyetheramines sold by Huntsman Corporation under the trade name JEFFAMINE®, the D-series comprising diamines and the T-series comprising triamines, the E-series comprising compounds which have a skeleton consisting substantially of polyethylene glycol, and the R series comprising highly reactive amines.

The D series products include amino-terminated polypropylene glycols of the general formula (II),

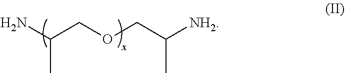

where x is a number having an average between 2 and 70. Commercially available products from this series are JEFFAMINE® D-230 (n˜2.5 Mw 230), JEFFAMINE® D-400 (n˜6.1/Mw=430), JEFFAMINE® D-2000 (n˜33/Mw 2,000) and JEFFAMINE® D-4000 (n˜68/MW 4,000).

The ED series products include amino-terminated polyethers based on a substantially polyethylene glycol skeleton having the general formula (III),

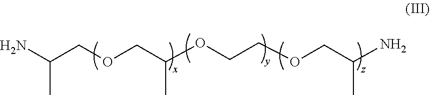

in which y is a number having an average between 2 and 40 and x z is a number having an average between 1 and 6. Commercially available products from this series are: JEFFAMINE® HK511 (y=2.0; x+z˜1.2 Mw 220), JEFFAMINE® ED-600 (y˜9.0; x+z˜3.6/Mw 600), JEFFAMINE® ED-900 (y˜12.5; x+z˜6.0/Mw 900) and JEFFAMINE® ED-2003 (y˜39; x+z˜6.0 Mw 2,000).

The EDR series products include amino-terminated polyethers having the general formula (IV)

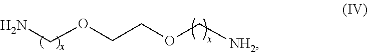

where x is an integer between 1 and 3. Commercially available products from this series are: JEFFAMINE® DER-148 (x=2/Mw 148) and JEFFAMINE® DER-176 (x=3/Mw 176).

The T series products comprise triamines which are obtained by reacting propylene oxide with a triol initiator and then aminating the terminal hydroxyl groups, and have the general formula (V), or isomers thereof

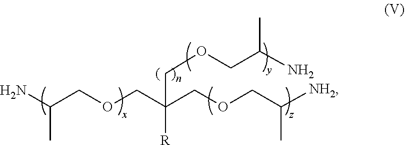

in which R is hydrogen or a C₁-C₄ alkyl group, preferably hydrogen or ethyl, n is 0 or 1 and x+y+z corresponds to the number of moles of propylene oxide units, where x+y+z is an integer between approximately 4 and approximately 100, in particular between approximately 5 and approximately 85. Commercially available products from this series are: JEFFAMINE® T-403 (R=C₂H₅; n=1; x+y+z=5-6/Mw 440), JEFFAMINE® T-3000 (R=H; n=0; x+y+z=50/Mw 3,000) and JEFFAMINE® T-5000 (R=H; n=0; x+y+z=85 Mw 5,000).

Also suitable are the secondary amines of the SD and ST series, the SD series comprising secondary diamines and the ST series comprising secondary triamines obtained from the above series by reductive alkylation of the amino groups in which the amino end groups are reacted with a ketone, for example acetone, and then reduced, such that sterically hindered secondary amino end groups which have the general formula (VI) are obtained

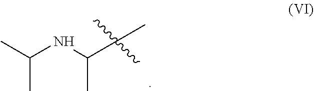

Commercially available products from this series are: JEFFAMINE® SD-231 (starting product D230/Mw 315), JEFFAMINE® SD-401 (starting product D-400/Mw 515), JEFFAMINE® SD-2001 (starting product D-2000/Mw 2050) and JEFFAMINE ST-404 (starting product T-403/Mw 565).

In a particularly preferred embodiment of the invention, polyaspartic acid esters, referred to as polyaspartics, are used as compounds having at least two amino groups, since the reactivity of said polyaspartics to isocyanate groups is significantly reduced in comparison with the other polyamines described above.

Suitable polyaspartic acid esters are selected from compounds of general formula (VII),

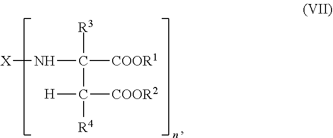

in which R¹ and R² can be the same or different and represent organic functional groups which are inert to isocyanate groups, can be identical or different to R³ and R⁴ and represent hydrogen or organic functional groups which are inert to isocyanate groups, X represents an n-valent organic functional group which is inert to isocyanate groups, and n represents an integer of at least 2, preferably from 2 to 6, more preferably from 2 to 4 and most preferably from 2. R¹ and R², preferably independently of one another, represent an optionally substituted hydrocarbon group, preferably a C₁-C₉ hydrocarbon group and more preferably a methyl, ethyl or butyl group and R³ and R⁴ preferably each represent hydrogen.

In one embodiment, X represents an n-valent hydrocarbon group which is obtained by removing the amino groups from an aliphatic or araliphatic polyamine, preferably by removing the primary amino groups from an aliphatic polyamine, particularly preferably diamine. In this context, the term “polyamine” covers compounds having two or more primary amino groups and optionally additional secondary amino groups, the primary amino groups preferably being terminal.

In a preferred embodiment, X represents a functional group such as that obtained by removing the primary amino groups from 1,4-diaminobutane, 1,6-diaminohexane, 2,2,4- or 2,4,4-trimethyl-1,6-diaminohexane, 1-amino-3,3,5-trimethyl-5-aminomethyl-cyclohexane, 4,4′-diamino-dicyclohexylmethane or 3,3′-dimethyl-4,4′-diamino-dicyclohexylmethane, diethylenetriamine and triethylenetetramine and where n in formula (VII) represents the number 2.

In this regard, reference is made to the application EP 0 403 921 A2 and EP 0 743 332 A1, the content of which is hereby incorporated into this application.

Mixtures of poly aspartic acid esters can also be used.

Suitable poly aspartic acid esters are sold by Covestro AG under the trade name DESMOPHEN®. Examples of commercially available products are: DESMOPHEN® NH 1220, DESMOPHEN® NH 1420 and DESMOPHEN® NH 1520.

The described compounds having at least two amino groups can be used individually or as a mixture, depending on the desired reactivity. In this case, the polyamines in particular can be used as bridging compounds if said polyamines are used in addition to the polyether polyamines or the polyaspartic acid esters.

If polyols are used as reactive components which are reactive to isocyanate compounds, all compounds having two or more hydroxyl groups can be used. The polyol is preferably composed of a skeleton made of polyester, polyether, polyurethane and/or alkanes or mixtures thereof. The skeleton can have a linear or branched structure and contain the functional hydroxyl groups terminally and/or along the chain.

In a preferred embodiment, the polyol contains one or more polyester polyols. Polyester polyols are preferred which are selected from condensation products of di- and polycarboxylic acids, e.g. aromatic acids such as phthalic acid and isophthalic acid, aliphatic acids such as adipic acid and maleic acid, cycloaliphatic acids such as tetrahydrophthalic acid and hexahydrophthalic acid and/or the derivatives thereof, such as anhydrides, esters or chlorides, and an excess amount of multifunctional alcohols, e.g. aliphatic alcohols such as ethanediol, 1,2-propanediol, 1,6-hexanediol, neopentyl glycol, glycerol, trimethylolpropane and cycloaliphatic alcohols such as 1,4-cyclohexanedimethanol.

Furthermore, the polyester polyols are selected from polyacrylate polyols, such as copolymers of esters of acrylic and/or methacrylic acid, such as ethyl acrylate, butyl acrylate, methyl methacrylate having additional hydroxyl groups, and styrene, vinyl ester and maleic acid ester. The hydroxyl groups in these polymers are introduced using functionalized esters of acrylic and methacrylic acid, e.g. hydroxyethyl acrylate, hydroxyethyl methacrylate and/or hydroxypropyl methacrylate.

Furthermore, the polyester polyols are selected from polycarbonate polyols. Usable polycarbonate polyols are polycarbonates containing hydroxyl groups, for example polycarbonate diols. These can be obtained by reacting carbonic acids or carbonic acid derivatives with polyols or by copolymerizing, alkylene oxides, such as propylene oxide, with CO_{z} Additionally or alternatively, the polycarbonates used are composed of linear aliphatic chains. Examples of suitable carbonic acid derivatives are, for example, carbonic acid diesters, such as diphenyl carbonate, dimethyl carbonate or phosgene.

Instead of, or in addition to, pure polycarbonate diols, polyether polycarbonate diols can also be used.

Furthermore, the polyester polyols are selected from polycaprolactone polyols, prepared by the ring-opening polymerization of ε-caprolactone using multifunctional alcohols, such as ethylene glycol, 1,2-propanediol, glycerol and trimethylolpropane.

In addition, polyether polyols are more preferably selected from addition products of, for example, ethylene and/or propylene oxide and multifunctional alcohols such as, for example, ethylene glycol, 1,2-propanediol, glycerol and/or trimethylolpropane.

In addition, polyurethane polyols which are prepared from polyaddition of diisocyanates having excess amounts of diols and/or polyols are more preferable.

Difunctional or multifunctional alcohols selected from C₂-C₁₀ alcohols having the hydroxyl groups at the ends and/or along the chain are more preferable.

Most preferable are the polyester polyols, polyether polyols and C2-C₁₀ alcohols mentioned above, which are di- and/or trifunctional and/or tetrafunctional.

Examples of suitable polyester polyols include DESMOPHEN® 1100, DESMOPHEN® 1652, DESMOPHEN® 1700, DESMOPHEN® 1800, DESMOPHEN® 670, DESMOPHEN® 800, DESMOPHEN® 850, DESMOPHEN® VP LS 2089. DESMOPHEN® VP LS 2249/1, DESMOPHEN® VP LS 2328. DESMOPHEN® VP LS 2388, DESMOPHEN® XP 2488 (Covestro AG), K-FLEX XM-360, K-FLEX 188, K-FLEX XM-359. K-FLEX A308 and K-FLEX XM-332 (King Industries).

Examples of suitable, commercially available polyether polyols include: ACCLAIM® POLYOL 12200 N, ACCLAIM® POLYOL 18200 N, ACCLAIM® POLYOL 4200, ACCLAIM® POLYOL 6300, ACCLAIM® POLYOL 8200 N, ARCOL® POLYOL 1070, ARCOL® POLYOL 1 105 S. DESMOPHEN® 1 1 10 BD, DESMOPHEN® 1 11 1 BD, DESMOPHEN® 1262 BD, DESMOPHEN® 1380 BT, DESMOPHEN® 1381 BT, DESMOPHEN® 1400 BT, DESMOPHEN® 2060 BD, DESMOPHEN® 2061 BD, DESMOPHEN® 2062 BD, DESMOPHEN® 3061 BT, DESMOPHEN® 401 1 T, DESMOPHEN® 4028 BD, DESMOPHEN® 4050 E, DESMOPHEN® 5031 BT, DESMOPHEN® 5034 BT. DESMOPHEN® 10WF15. DESMOPHEN® 10WF16. DESMOPHEN®10WF18, DESMOPHEN®5168T and DESMOPHEN®5035 BT (Bayer; Covestro); Lupranol 2043, Lupranol 2048, Lupranol 2090, Lupranol 2092, Lupranol 2095, Pluriol E600 (BASF); Voranol CP 755, Voranol RA 800, Voranol CP 6001, Voranol EP 1900 (Dow) or mixtures of polyester and polyether polyols such as WorleePol 230 (Worlee).

Examples of suitable alcohols include ethanediol, propanediol, propanetriol, butanediol, butanetriol, pentanediol, pentanetriol, hexanediol, hexanetriol, heptanediol, heptanetriol, octanediol, octanetriol, nonanediol, nonanetiol, decanediol and decanetrol.

In a preferred embodiment, the multicomponent composition comprises a mixture of one or more compounds having two amino groups and one or more polyols. A mixture of one or more polyols with one or more polyaspartic esters is particularly preferred, a mixture of one or more polyaspartic esters with triols and/or tetraols being particularly preferred.

The ratio of the OH groups of the polyol and the NH groups of the compound having at least two amino groups OH:NH is preferably 0.05 eq: 0.95 eq to 0.6 eq: 0.4 eq. more preferably used in the ratio 0.1 eq: 0.9 eq to 0.5 eq: 0.5 eq and most preferably used in the ratio 0.2 eq: 0.8 eq to 0.4 eq: 0.6 eq.

A catalyst is preferably used for reacting the aliphatic isocyanate compound with the reactive component which is reactive to isocyanate groups. The catalyst is preferably selected from amines, tin-containing compounds, bismuth-containing compounds, zirconium-containing compounds, aluminum-containing compounds or zinc-containing compounds. Said catalyst is preferably tin octoate, tin oxalate, tin chloride, dioctyltindi-(2-ethylhexanoate), dioctyltin dilaurate, dioctyltin dithioglycolate, dibutyltin dilaurate, monobutyltin tris-(2-ethylhexanoate), dioctyltin dineodecanoate, dibutyltin dineodecanoate, dibutyltin diacetate, dibutyltin oxide, monobutyltin dihydroxychloride, organotin oxide, monobutyltin oxide, dioctyltin dicarboxylate, dioctyltin stannoxane, bismuth carboxylate, bismuth oxide, bismuth neodecanoate, zinc neodecanoate, zinc octoate, zinc acetylacetonate, zinc oxalate, zinc acetate, zinc carboxylate, aluminum chelate complex, zirconium chelate complex, dimethylaminopropylamine, N,N-dimethylcyclohexylamine, N,N-dimethylethanolamine, N-(3-dimethylaminopropyl)-N,N-diisopropanolamine, N-ethylmorpholine, N-methylmorpholine, pentamethyldiethylenetriamine and/or triethylenediamine. Examples of suitable catalysts are Borchi® Kat 24, Borchi® Kat 320, Borchi® Kat 15 (Borchers), TIB KAT 129, TIB KAT P129, TIB KAT 160, TIB KAT 162, TIB KAT 214, TIB KAT 216, TIB KAT 218, TIB KAT 220. TIB KAT 232, TIB KAT 248, TIB KAT 248 LC, TIB KAT 250, TIB KAT 250, TIB KAT 256, TIB KAT 318, TIB Si 2000, TIB KAT 716, TIB KAT 718, TIB KAT 720, TIB KAT 616, TIB KAT 620, TIB KAT 634, TIB KAT 635, (TIB Chemicals), K-KAT® XC-B221, K-KAT® 348, K-KAT® 4205. K-KAT®5218. K-KAT® XK-635, K-KAT® XK-639, K-KAT® XK-604, K-KAT® XK-618 (King Industries), JEFFCAT® DMAPA, JEFFCAT® DMCHA, JEFFCAT® DMEA, JEFFCAT® DPA, JEFFCAT® NEM, JEFFCAT® NMM, JEFFCAT® PMDETA, JEFFCAT® TD-100 (Huntsman) and DABCO 33LV (Sigma Aldrich). The multicomponent composition particularly preferably comprises at least one tin-containing compound as a catalyst.

According to the invention, the composition contains an additive which forms an insulation layer, it being possible for the additive to comprise an individual compound and a mixture of a plurality of compounds.

It is expedient for the additives which are used as the additives which form an insulation layer to be of the kind that function by forming an expanded, insulating layer of flame-retardant material under the effect of heat, which layer protects the substrate from overheating, and thereby prevents or at least delays changes to the mechanical and static properties of load-bearing components due to the effect of heat. The formation of a voluminous insulating layer, specifically an ash layer, can be formed by the chemical reaction of a mixture of corresponding compounds which are matched to one another, which compounds react with one another under the effect of heat. Systems of this kind are known to a person skilled in the art as chemical intumescence, and can be used according to the invention. Alternatively, the voluminous, insulating layer can be formed by physical intumescence. The two systems can each be used according to the invention individually, or together as a combination.

At least three components are generally required for forming an intumescent layer by chemical intumescence: a carbon source, a dehydrogenation catalyst, and a gas former, which are often contained in a binder. Under the effect of heat, the binder softens and the fire protection additives are released, such that said additives react with one another, in the case of chemical intumescence, or can expand, in the case of physical intumescence. The acid which acts as the catalyst for carbonizing the carbon source is formed from the dehydrogenation catalyst, by means of thermal decomposition. At the same time, the gas former decomposes thermally to form inert gases which cause an expansion of the carbonized material, and optionally the softened binder, to form a voluminous, insulating foam.

In one embodiment of the invention in which the insulating layer is formed by chemical intumescence, the additive which forms an insulation layer comprises at least one carbon-skeleton former, if the binder cannot be used as such, at least one acid former, at least one gas former, and at least one inorganic skeleton former. The components of the additive are particularly selected such that they can develop synergism, as a result of which some of the compounds can fulfill a plurality of functions.

Compounds which are usually used in intumescent fire protection agents and are known to a person skilled in the art, such as compounds similar to starch. e.g. starch and modified starch, and/or polyhydric alcohols (polyols), such as saccharides and polysaccharides and/or a thermoplastic or duroplastic polymer resin binder, such as a phenolic resin, a urea resin, a polyurethane, polyvinyl chloride, poly(meth)acrylate, polyvinyl acetate, polyvinyl alcohol, a silicone resin and/or a rubber, can be used as carbon sources. Suitable polyols are polyols from the group of sugar, pentaerythrite, dipentaerythrite, tripentaerythrite, polyvinyl acetate, polyvinyl alcohol, sorbitol and EO-PO-polyols. Pentaerythrite, dipentaerythrite or polyvinyl acetate are preferably used.

It should be mentioned that the polymer which acts as a binder can itself also function as a carbon source in the event of a fire, such that the addition of an additional carbon source is not always necessary.

Compounds which are usually used in intumescent fire protection agents and are known to a person skilled in the art, such as a salt or an ester of an inorganic, non-volatile acid, selected from sulfuric acid, phosphoric acid or boric acid, can be used as dehydrogenation catalysts or acid formers. Phosphorus-containing compounds, the range of which is very large, are mainly used, since said compounds cover a plurality of oxidation states of phosphorus, such as phosphines, phosphine oxides, phosphonium compounds, phosphates, elemental red phosphorus, phosphites and phosphates. The following can be mentioned by way of example as phosphoric acid compounds: monoammonium phosphate, diammonium phosphate, ammonium phosphate, ammonium polyphosphate, melamine phosphate, melamine resin phosphates, potassium phosphate, polyol phosphates such as pentaerythritol phosphate, glycerol phosphate, sorbitol phosphate, mannitol phosphate, dulcitol phosphate, neopentyl glycol phosphate, ethylene glycol phosphate, dipentaerythritol phosphate and the like.

Preferably, a polyphosphate or an ammonium polyphosphate is used as a phosphoric acid compound. In this regard, melamine resin phosphates are understood to be compounds such as the reaction products of Lamelite C (melamine-formaldehyde resin) with phosphoric acid. The following can be mentioned by way of example as sulfuric acid compounds: ammonium sulfate, ammonium sulfamate, nitroaniline bisulfate, 4-nitroaniline-2-sulfonic acid and 4,4-dinitrosulfanilamide and the like. Melamine borate can be mentioned by way of example as a boric acid compound.

The compounds which are usually used in fire protection agents and are known to a person skilled in the art, such as cyanuric acid or isocyanic acid and the derivatives thereof, or melamine and the derivatives thereof, can be used as gas formers. Compounds of this kind are cyanamide, dicyanamide, dicyandiamide, guanidine and the salts thereof, biguanide, melamine cyanurate, cyanic acid salts, cyanic acid esters and amides, hexamethoxymethyl melamine, dimelamine pyrophosphate, melamine polyphosphate, melamine phosphate. Hexamethoxymethyl melamine or melamine (cyanuric acid amide) is preferably used.

Components which have a mode of action which is not limited to a single function, such as melamine polyphosphate, which acts as an acid former and as a gas former, are also suitable. Further examples are described in GB 2 007 689 A1, EP 139 401 A1, and U.S. Pat. No. 3,969,291 A1.

In one embodiment of the invention, in which the insulating layer is formed by physical intumescence, the additive which forms an insulation layer comprises at least one thermally expandable compound, such as a graphite intercalation compound, which compounds are also referred to as expandable graphite. Said compounds can also be contained in the binder, in particular homogeneously.

For example, known intercalation compounds of sulfuric acid, nitric acid, acetic acid, Lewis acids and/or other strong acids in graphite can be used as expandable graphite. These are also referred to as graphite salts. Expandable graphites which give off SO₂, SO₃, CO₂, H₂O, NO and/or NO₂ while expanding at temperatures of 120 to 350° C., for example, are preferred. The expandable graphite can be present, for example, in the form of flakes having a maximum diameter in the range of 0.1 to 5 mm. Said diameter is preferably in the range of 0.5 to 3 mm. Expandable graphites suitable for the present invention are commercially available. In general, the expandable graphite particles are evenly distributed in the fire protection elements according to the invention. The concentration of expandable graphite particles can, however, also be varied in punctiform, pattern-like, planar and/or sandwich-like manner. In this regard, reference is made to EP 1489136 A1, the content of which is hereby incorporated into this application.

In a further embodiment of the invention, the insulating layer is formed both by chemical and by physical intumescence, such that the additive which forms an insulation layer comprises a carbon source, a dehydrogenation catalyst, and a gas former, and also thermally expandable compounds.

In principle, the additive which forms an insulation layer can be contained in the multicomponent composition in a very broad weight percent range, specifically preferably in an amount of 10 to 70 wt. % based on the total weight of the multicomponent composition. If the insulating layer is formed by physical intumescence, the additive which forms an insulation layer is preferably contained in an amount of 10 to 40 wt. %, based on the total weight of the multicomponent composition. In order to achieve the highest possible intumescence rate, the proportion of the additive which forms an insulation layer in the overall formulation is set as high as possible and care must be taken that the viscosity of the composition does not become too high, such that the composition is still easily processed. The proportion is preferably 12 to 35 wt. % and particularly preferably 15 to 30 wt. %, based on the total weight of the multicomponent composition.

Because the ash crust formed in the event of a fire is generally too unstable, and, depending on the density and structure thereof, can be blown away by air streams, for example, which has a negative effect on the insulating effect of the coating, preferably at least one ash crust stabilizer is added to the components listed above. The fundamental mode of action is in this case that the inherently very soft carbon layers being formed are mechanically strengthened by inorganic compounds. The addition of an ash crust stabilizer of this kind contributes to significantly stabilizing the intumescence crust in the event of a fire, since said additives increase the mechanical strength of the intumescent layer and/or prevent it from dripping off.

The compounds which are commonly used in fire protection formulations and are known to a person skilled in the art, for example expandable graphite and particulate metals, such as aluminum, magnesium, iron, and zinc, can be used as ash crust stabilizers or skeleton formers. The particulate metal can be present in the form of a powder, flakes, scales, fibers, threads and/or whiskers, the particulate metal in the form of powder, flakes or scales having a particle size of ≤50 μm, preferably of 0.5 to 10 μm. If the particulate metal is used in the form of fibers, threads and/or whiskers, a thickness of 0.5 to 10 μm and a length of 10 to 50 μm are preferred. Alternatively or additionally, an oxide or a compound of a metal from the group comprising aluminum, magnesium, iron or zinc can be used as an ash crust stabilizer, in particular iron oxide, preferably iron trioxide, titanium dioxide, a borate, such as zinc borate and/or a glass frit made of glasses which have a low melting point, having a melting temperature which is preferably at or above 400° C., phosphate or sulfate glasses, melamine polyzinc sulfates, ferrous glasses or calcium boron silicates. The addition of an ash crust stabilizer of this kind contributes to significantly stabilizing the ash crust in the event of a fire, since said additives increase the mechanical strength of the intumescent layer and/or prevent it from dripping off. Examples of additives of this kind are also found in U.S. Pat. Nos. 4,442,157 A, 3,562,197 A, GB 755 551 A, and EP 138 546 A1.

Ash crust stabilizers such as melamine phosphate or melamine borate can be contained in addition.

Optionally, one or more fire protection agents can be added to the composition according to the invention, such as phosphate esters, halogen-containing compounds such as tri-(2-chloroisopropyl)-phosphate (TCPP), tris-(2-ethylhexyl)-phosphate, dimethylpropane phosphonate, triethyl phosphate and the like. Some compounds of this kind are described, for example, in S. V. Levchik, E. D. Weil, Polym. Int. 2004, 53, 1901-1929. The fire protection agents can preferably be contained in an amount of 3 to 6 wt. %, based on the total composition.

According to the invention, the composition contains a blowing agent which comprises one or more compounds which are able to release carbon dioxide (CO₂) by reaction. All common chemical blowing agents which release carbon dioxide by means of a chemical reaction between two constituents are suitable as blowing agents. According to the invention, the individual constituents of the blowing agent are separated from one another in a reaction-inhibiting manner before the composition is used.

In the simplest embodiment of the invention, the blowing agent comprises water or consists of water, which releases carbon dioxide after mixing with aliphatic isocyanate. The weight percent proportion of water is preferably 0.1 to 10 wt. %, more preferably 0.2 to 8 wt. % and even more preferably 0.2 to 6 wt. %, based on the total weight of the multicomponent composition.

In a preferred embodiment, the multicomponent composition comprises a foam catalyst which catalyzes the reaction of the aliphatic isocyanate with water to form carbon dioxide. N,N,N′-trimethyl-N′-hydroxyethylbisaminoethyl ether (Jeffcat ZF-10), bis-(2-dimethylaminoethyl)ether (Jeffcat ZF-20), 70% bis-(2-dimethylaminoethyl)ether in dipropylene glycol (Jeffcat ZF-22), and N-[2-[2-(dimethylamino)ethoxy]ethyl]-N-methyl-1,3-propane diamine (Dabco NE300) are preferably used in this case.

In another embodiment, the blowing agent comprises an acid and a compound that can react with acids to form carbon dioxide.

Carbonate-containing and hydrogen carbonate-containing compounds, in particular metal or (in particular quaternary) ammonium carbonates, such as carbonates of alkali metals or alkaline earth metals, for example CaCO₃, NaHCO₃, Na₂CO₃, K₂CO₃. (NH₄)₂CO₃ and the like, chalk (CaCO₃) being preferred, can be used as compounds which are able to react with acids to form carbon dioxide. In this case, various types of chalks having different grain sizes and a different surface condition can be used, such as, for example, coated or uncoated chalk, or mixtures of two or more thereof. Coated chalk types are preferably used, since they react more slowly with the acid and thus ensure controlled foaming or a matched foaming and curing time.

Any acidic compound which is able to react with carbonate-containing or hydrogen carbonate-containing compounds to eliminate carbon dioxide can be used as the acid, such as phosphoric acid, hydrochloric acid, sulfuric acid, ascorbic acid, polyacrylic acid, benzoic acid, toluenesulfonic acid, tartaric acid, glycolic acid, lactic acid; organic mono-, di- or polycarboxylic acids such as acetic acid, chloroacetic acid, trifluoroacetic acid, fumaric acid, maleic acid, citric acid or the like, aluminum dihydrogen phosphate, sodium hydrogen sulfate, potassium hydrogen sulfate, aluminum chloride, urea phosphate and other acid-releasing chemicals or mixtures of two or more thereof. The acid generates the gas as the actual blowing agent.

An aqueous solution or an inorganic and/or organic acid can be used as the acid component. Buffered solutions of citric, tartaric, acetic, phosphoric acid and the like can also be used.

In order to impart greater stability to the formed foam, the formed cells must remain stable until the binder is cured, in order to prevent the collapse of the polymeric foam structure. Stabilization becomes more necessary the lower the density of the foam material is intended to be, i.e. the greater the volume expansion. Stabilization is usually achieved using foam stabilizers. The foams generally have densities of approximately 100-300 g/cm³, preferably of 110 to 210 g/L, measured according to DIN EN ISO 845.

The composition according to the invention can therefore further contain a foam stabilizer if necessary. Alkyl polyglycosides, for example, are suitable foam stabilizers. These can be obtained according to methods known per se to a person skilled in the art, by reacting longer-chain monoalcohols with mono-, di-, or polysaccharides. The longer-chain monoalcohols, which optionally can also be branched, preferably have 4 to 22 C atoms, preferably 8 to 18 C atoms and particularly preferably 10 to 12 C atoms in an alkyl functional group. Specifically, 1-butanol, 1-propanol, 1-hexanol, 1-octanol, 2-ethylhexanol, 1-decanol, 1-undecanol, 1-dodecanol (lauryl alcohol), 1-tetradecanol (myristyl alcohol) and 1-octadecanol (stearyl alcohol) can be mentioned as longer-chain monoalcohols. Mixtures of the aforementioned longer-chain monoalcohols can also be used. Other foam stabilizers include anionic, cationic, amphoteric and nonionic surfactants, which are known per se, and mixtures thereof. Alkyl polyglycosides, EO/PO block copolymers, alkyl or aryl alkoxylates, siloxane alkoxylates, esters of sulfosuccinic acid and/or alkaline metal or alkaline earth metal alkanoates are preferably used. EO/PO block copolymers are particularly preferably used.

The foam stabilizers can be contained in any one of the components of the composition according to the invention, as long as they do not react with one another.

In one embodiment, the composition according to the invention further contains at least one further constituent, selected from plasticizers, crosslinking agents, biocides, organic and/or inorganic admixtures and/or further additives.

The plasticizer has the task of plasticizing the cured polymer network. The plasticizer also has the task of introducing an additional liquid component, such that the fillers are completely wetted, and the viscosity is set such that the coating becomes processable. The plasticizer can be contained in the composition in such an amount that it can sufficiently fulfill the functions described above.

Suitable plasticizers are selected from derivatives of benzoic acid, phthalic acid, e.g. phthalates, such as dibutyl-, dioctyl-, dicyclohexyl-, diisooctyl-, diisodecyl-, dibenzyl- or butylbenzyl phthalate, trimellitic acid, pyromellitic acid, adipic acid, sebacic acid, fumaric acid, maleic acid, itaconic acid, caprylic acid and citric acid, alkylphosphate esters and derivatives of polyesters and polyethers, epoxidized oils, C₁₀-C₂₁ alkylsulfonic acid esters of phenols, and alkylesters. The plasticizer is preferably an ester derivative of terephthalic acid, a triol ester of caprylic acid, a glycol diester, diol esters of aliphatic dicarboxylic acids, an ester derivative of citric acid, a secondary alkylsulfonic acid ester, ester derivatives of glycerin with epoxy groups and ester derivatives of phosphates. The plasticizer is more preferably bis(2-ethylhexyl)terephthalate, trihydroxymethylpropylcaprylate, triethylene glycol-bis(2-ethylhexanoate), 1,2-cyclohexane dicarboxylic acid diisononyl ester, a mixture of 75-85% of secondary alkylsulfonic acid esters, 15-25% of secondary alkane disulfonic acid diphenylesters, and 2-3% of non-sulfonated alkanes, triethylcitrate, epoxidized soybean oil, tri-2-ethylhexylphosphate or a mixture of n-octylsuccinate and n-decylsuccinate. The plasticizer is most preferably a phosphate ester, since said ester can function as a plasticizer and as a fire protection agent.

The composition can preferably contain the plasticizer in an amount of up to 30 wt. %, more preferably up to 20 wt. % and even more preferably up to 8 wt. %, based on the total composition.

In addition to the additives already described, the composition can optionally contain common aids such as wetting agents, for example based on polyacrylates and/or polyphosphates, pigments, fungicides, or diverse fillers, such as vermiculite, inorganic fibers, quartz sand, micro-glass beads, mica, silicon dioxide, mineral wool, and the like.

Additional additives, such as thickeners and/or rheology additives, and fillers can be added to the composition. Polyhydroxycarboxylic acid amides, urea derivatives, salts of unsaturated carboxylic acid esters, alkylammonium salts of acidic phosphoric acid derivatives, ketoximes, amine salts of p-toluenesulfonic acid, amine salts of sulfonic acid derivatives, and aqueous or organic solutions or mixtures of the compounds are preferably used as rheology additives, such as anti-settling agents, anti-runoff agents, and thixotropic agents. In addition, rheology additives based on pyrogenic or precipitated silicic acids, or based on silanized pyrogenic or precipitated silicic acids can be used. The rheology additives are preferably pyrogenic silicic acids, modified and non-modified phyllosilicates, precipitation silicic acids, cellulose ethers, polysaccharides, PU and acrylate thickeners, urea derivatives, castor oil derivatives, polyamides and fatty acid amides and polyolefins, if they are present in solid form, powdered celluloses and/or suspension agents such as xanthan gum.

The composition according to the invention can be packaged as a two-component or multi-component system, the term multi-component system also including two-component systems. The composition is preferably packaged as a two-component system in which the individual constituents of the blowing agent are separated from one another in a reaction-inhibiting manner before the composition is used, and the aliphatic isocyanate compounds are separated from the reactive component, which is reactive to isocyanate groups, in a reaction-inhibiting manner before the composition according to the invention is used.

The further constituents of the composition are divided up in accordance with their compatibility with one another and with the compounds contained in the composition, and can be contained in one of the two components or in both components. Furthermore, the division of the further constituents, in particular of the solid constituents, can depend on the amounts in which these are supposed to be contained in the composition. By means of a corresponding division, a higher proportion, relative to the total composition, may occur. In this case, the fire protection additive which forms an insulation layer can be contained, in one or more components, as a total mixture or divided into individual components. The division takes place depending on the compatibility of the compounds contained in the composition, such that no reaction between the compounds contained in the composition, or mutual disturbance, or a reaction of these compounds with the compounds of the other constituents can take place. This is dependent on the compounds used.

The invention further relates to the use of a composition according to the invention for foaming openings, cable and pipe feedthroughs in walls, floors and/or ceilings, joints between ceilings and wall parts, between wall openings and construction parts which are to be installed, such as window and door frames, between ceilings and walls and between outside walls and curtain-wall facades of buildings for the purpose of fire protection.

The invention further relates to a process for producing a foam material, in which the components of the multicomponent composition are mixed with one another at or near the place of use and the mixture is applied or introduced at the desired location, for example into a joint, opening or gap, into a cavity or onto a surface. In this case, the foams are what are referred to as in-situ foams.

The invention further relates to molded bodies, for example, which can be obtained by means of the method described above, it being possible for the foam material to be produced in a mold, for example. In this case, it is conceivable to use a molded body to produce molded bodies that are inserted into wall openings, e.g. cable bulkheads. The use for bulkheads of cables, pipes, busbars and/or joints is also preferable. Said molded bodies can also preferably be used as seals for fire protection, for preparing fire protection adhesive compounds, for coating surfaces and for producing sandwich components or composite panels.

The molded bodies foam up in the event of a fire, which prevents flames from spreading, and said bodies are therefore suitable as sealing elements, safety devices, fire barriers or claddings. Said bodies can therefore be used for jointing, as seals for cable penetrations and for sealing wall openings. The use of a fire protection element as the inner coating of fire-retardant doors, which coating foams and has an insulating effect in the event of a fire, should be considered, as should producing door seals or other seals that foam and seal the upstream slot in the event of a fire.

The invention is explained in greater detail below with reference to some examples.

### EMBODIMENTS

To prepare compositions 1 to 3 according to the invention and comparative compositions V1 to V3, the polyol(s) and/or the polyaspartic esters were mixed with water, catalysts, foam stabilizer and solids. The isocyanate component was then added and the mixture was stirred for 20 s. Alternatively, the polyol(s), the polyaspartic acid ester, water, catalysts, foam stabilizer and solids were transferred into a commercially available 2K cartridge separately from the isocyanate component, and the foam was extruded by a static mixer.

TABLE 1
Constituents of compositions 1 to 3
according to the invention [wt. %]

| Component | 1 | 2 | 3 |
|---|---|---|---|
| Aliphatic isocyanate ¹⁾ | 31.30 | 48.94 | 29.64 |
| Polyaspartic acid ester ²⁾ | 39.90 | — | 22.67 |
| Polyol 1 ³⁾ | — | 16.20 | — |
| Polyol 2 ⁴⁾ | — | — | 18.89 |
| Aminopolyol ⁵⁾ | — | 10.80 | — |
| Water | 5.60 | 0.40 | 5.60 |
| Foaming catalyst ⁶⁾ | 1.60 | 0.80 | 1.60 |
| Foam stabilizer ⁷⁾ | 1.60 | 1.95 | 1.60 |
| Fungicide ⁸⁾ | 0.08 | 0.08 | 0.08 |
| Ammonium polyphosphate ⁹⁾ | 3.04 | 3.06 | 3.04 |
| Expandable graphite ¹⁰⁾ | 15.62 | 15.7 | 15.62 |
| Iron oxide (Fe₂O₃) ¹¹⁾ | 1.26 | 1.27 | 1.26 |
| Gelling catalyst 1 ¹²⁾ | — | 0.27 | — |
| Gelling catalyst 2 ¹³⁾ | — | 0.54 | — |
| Density [g/L] | 207 | 188 | 119 |

¹⁾ Desmodur N 3600 from Covestro, Germany
²⁾ Desmophen NH 1420 from Covestro, Germany
³⁾ Pluriol E 600 from BASF
⁴⁾ Voranol CP 755 from Dow
⁵⁾ Voranol RA 800 from Dow
⁶⁾ Jeffcat ZF-10 from Huntsmann Corporation
⁷⁾ Dabco DC 198 from Evonik
⁸⁾ Actidide MKP from Thor, Speyer, Germany
⁹⁾ Exolit ® AP 462 from Clariant;
¹⁰⁾ Mixture of 84% Nord-Min ® 351 and 16% Nord-Min ® 20 from Nordmann-Rassmann, Hamburg, Germany;
¹¹⁾ Bayferrox 130 M from Lanxess
¹²⁾ Dabco 33-LV from Evonik
¹³⁾ TIB CAT 216 from TIB Chemicals

TABLE 2
Constituents of the comparative compositions V1 to V3 [in wt. %]

| Component | V1 | V2 | V3 |
|---|---|---|---|
| Aromatic isocyanate ¹⁾ | 27.16 | 41.94 | 26.13 |
| Polyaspartic acid ester ²⁾ | 47.64 | — | 27.51 |
| Polyol 1 ³⁾ | — | 20.67 | — |
| Polyol 2 ⁴⁾ | — | — | 22.92 |
| Aminopolyol ⁵⁾ | — | 13.78 | — |
| Water | 2.80 | 0.29 | 1.60 |
| Foaming catalyst ⁶⁾ | 0.80 | 0.66 | 0.24 |
| Foam stabilizer ⁷⁾ | 1.60 | 2.49 | 1.60 |
| Fungicide ⁸⁾ | 0.08 | 0.08 | 0.08 |
| Ammonium polyphosphate ⁹⁾ | 3.04 | 3.03 | 3.04 |
| Expandable graphite ¹⁰⁾ | 15.62 | 15.57 | 15.62 |
| Iron oxide (Fe₂O₃) ¹¹⁾ | 1.26 | 1.26 | 1.26 |
| Gelling catalyst 1 ¹²⁾ | — | 0.22 | — |
| Gelling catalyst 2 ¹³⁾ | — | — | — |
| Density [g/L] | 148 | 132 | 138 |

¹⁾ Desmodur 44V from Covestro, Germany
²⁾ Desmophen NH 1420 from Covestro, Germany
³⁾ Pluriol E 600 from BASF
⁴⁾ Voranol CP 755 from Dow
⁵⁾ Voranol RA 800 from Dow
⁶⁾ Jeffcat ZF-10 from Huntsmann Corporation
⁷⁾ Dabco DC 198 from Evonik
⁸⁾ Actidide MKP from Thor, Speyer, Germany
⁹⁾ Exolit ® AP 462 from Clariant;
¹⁰⁾ Mixture of 84% Nord-Min ® 351 and 16% Nord-Min ® 20 from Nordmann-Rassmann, Hamburg, Germany;
¹¹⁾ Bayferrox 130 M from Lanxess
¹²⁾ Dabco 33-LV from Evonik

Determination of Expansion Factors

To determine the expansion factors, both the multicomponent composition according to the invention, according to examples 1 to 3, and the comparative compositions V1 to V3 were foamed freely. A cylindrical sample having a diameter of 4.5 cm and a height of 2 cm was punched out of each of the foamed foams. This sample was heated in an M-TMA apparatus (Makro-TMA 2 from ASG Analytik-Service in cooperation with Hilti; year of manufacture 2004) under a load of 100 g at 15 K/min to 620° C. The residue was measured in wt. % and the expansion factor was measured based on the original sample.

The stability of the obtained ash crust was determined using a texture analyzer (CT3 from Brookfield). For this purpose, the sample was penetrated using a T7 element at a constant speed of 0.5 mm/s. The force used is measured as a function of the depth of penetration. The higher the force, the harder the ash crust. It could be shown that all of the compositions according to the invention have a sufficient ash crust stability.

TABLE 3
Results of the determination of the expansion factor in M-TMA

| | Residue [wt. %] | Expansion factor |
|---|---|---|
| Example 1 | 23 | 1.6 |
| Example 2 | 19.5 | 1.4 |
| Example 3 | 20.5 | 1.5 |
| Example V1 | 30 | 1.6 |
| Example V2 | 31 | 1.4 |
| Example V3 | 30.1 | 1.2 |

As shown in table 3, the compositions according to the invention provide at least the same expansion factor with a lower residue, such that the compositions according to the invention overall show an improved expansion factor.

Furthermore, all fire protection foams according to the invention have excellent application properties. The applied foam has a sufficient flexibility, such that the user can model the foam and bring it into the desired shape before curing has taken place.

1: A foamable, multi-component composition which forms an insulation layer, comprising:
i) at least one aliphatic isocyanate compound having an average NCO functionality of 1 or more,
i) at least one reactive component which is reactive to isocyanate groups, selected from the group consisting of compounds having at least two amino groups, polyols, and combinations thereof,
iii) at least one fire protection additive which forms an insulation layer, and
iv) a blowing agent comprising one or more compounds which are able to release CO₂ by reaction,
wherein individual constituents of the blowing agent are separated from one another in a reaction-inhibiting manner before the multi-component composition is used, and the at least one aliphatic isocyanate compound is separated from the at least one reactive component which is reactive to isocyanate groups, in a reaction-inhibiting manner.

2: The composition according to claim wherein the blowing agent comprises water.

3: The composition according to claim 1, wherein the at least one reactive component which is reactive to isocyanate groups is selected from the group consisting of a polyamine, a polyether polyamine, a polyaspartic acid ester, and a mixture thereof.

4: The composition according to claim 3, wherein the at least one reactive component which is reactive to isocyanate groups comprises at least one polyaspartic acid ester of general formula (VII), 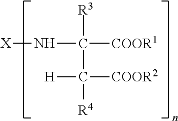
in which
R¹ and R² can be the same or different and represent organic functional groups which are inert to isocyanate groups,
R³ and R⁴ can be the same or different and represent hydrogen or organic functional groups which are inert to isocyanate groups,
X represents an n-valent functional organic group that is inert to isocyanate groups, and
n represents an integer of at least 2.

5: The composition according to claim 3, wherein the at least one reactive component which is reactive to isocyanate groups further comprises at least one polyol.

6: The composition according to claim 5, wherein the at least one polyol is selected from the group consisting of a polyester sir a polyether polyol, a hydroxylated poly urethane, an alkane, and a mixture thereof,
wherein each of the at least one polyol has at least two hydroxyl groups per molecule.

7: The composition according to claim 1, wherein a quantitative proportion of the at least one aliphatic isocyanate compound and the at least one reactive component which is reactive to isocyanate groups is selected such that an equivalent proportion of isocyanate groups of the at least one aliphatic isocyanate compound to the at least one reactive component which is reactive to isocyanate groups is between 0.3 and 1.7.

8: The composition according to claim 1, wherein the composition further contains a catalyst for reaction between the at least one aliphatic isocyanate compound and the at least one reactive component which is reactive to isocyanate groups.

9: The composition according to claim 1, wherein the at least one fire protection additive which forms the insulation layer is selected from the group consisting of a graphite intercalation compound, expandable silicate material, and combinations thereof.

10: The composition according to claim 9, wherein the at least one fire protection additive which forms the insulation layer further contains an ash crust stabilizer.

11: The composition according to claim 1, wherein the composition further contains a foam stabilizer.

12: The composition according to claim 1, wherein the composition further contains at least one further constituent which is selected from the group consisting of a plasticizer, an inorganic filler, and other additives.

13: A method, comprising: foaming, with the composition according to claim 1, an opening; a cable feedthrough or a pipe feedthrough in walls, floors, and/or ceilings; or a joint between ceilings and wall parts, between wall openings and construction parts which are to be installed, between ceilings and walls, and between outside walls and curtain-wall facades of buildings.

14: A molded body, obtained from the composition according to claim 1, wherein respective components are mixed together to form a mixture, and the mixture is foamed in a mold.
